(19) United States
(12) Patent Application Publication
(10) Pub. No.: US 2024/0095774 A1
(43) Pub. Date: Mar. 21, 2024

(54) SYSTEM AND METHOD FOR HANDLING UNDERPERFORMING SEARCHES

(71) Applicant: W.W. Grainger, Inc., Lake Forest, IL (US)

(72) Inventors: Jean-Marc Francois Reynaud, Chicago, IL (US); Geoffry A. Westphal, Evanston, IL (US); Thomas Allen Mathis, Tolono, IL (US); Immanuel Savio Donbosco, Bloomington, IN (US); Yen-Chen Chou, Evanston, IL (US)

(21) Appl. No.: 18/455,932

(22) Filed: Aug. 25, 2023

Related U.S. Application Data
(60) Provisional application No. 63/406,961, filed on Sep. 15, 2022.

(51) Int. Cl. G06Q 30/0242; G06F 16/9535; G06Q 30/0601

(52) U.S. Cl. CPC G06Q 30/0244; G06F 16/9535; G06Q 30/0631; G06Q 30/0633

(57) ABSTRACT

A search engine coupled to a database of product information is provided a search query having a datapoint and the search engine uses at least the datapoint to generate a search result. A vendor system associated with the search engine subsequently uses one or more interactions with the generated search result to update a conversion value that is linked within a datastore of the vendor system to the datapoint. When it is determined by the vendor system that the updated conversion value that is linked within the datastore to the datapoint was caused to exceed a predetermined threshold value, the vendor system causes a notification to be sent to one or more consumers that previously provided the datapoint for use in a search by the search engine.

### RELATED APPLICATION INFORMATION

This application claims the benefit of U.S. Application No. 63/406,961, filed on Sep. 15, 2022, the disclosure of which is incorporated herein by reference in its entirety.

### BACKGROUND

When a customer searches a website of a vendor, looking for a product to purchase, the website of the vendor can, on occasion, fail to provide a search result that the customer views as being relevant, e.g., the search result is a null search result or includes product that the customer does not desire. In most instances, the website of the vendor fails to provide a desirable search result to a customer simply because the vendor is not selling the product the customer is looking for. Accordingly, a need exists for a system and method that will allow a vendor to inform a customer that experienced an undesirable search result that the product that the customer was searching for can now be purchased from the vendor.

### SUMMARY

The following generally describes a system and method for handling underperforming searches and, more particularly, describes a system and method that will provide a means for a vendor to inform a customer that experienced an undesirable search result that the vendor now offers for sale the product that the customer was previously searching for. To this end, a search engine coupled to a database of product information is provided a search query having a datapoint and the search engine uses at least the datapoint to generate a search result. A vendor system associated with the search engine subsequently uses one or more interactions with the generated search result to update a conversion value that is linked within a datastore of the vendor system to the datapoint. When it is determined by the vendor system that the updated conversion value that is linked within the datastore to the datapoint was caused to exceed a predetermined threshold value, i.e., determines that an underperforming search has transitioned to a performing search, the vendor system causes a notification to be sent to one or more consumers that previously provided the datapoint for use in a search by the search engine.

While the forgoing provides a general explanation of the subject system and method, a better understanding of the objects, advantages, features, properties and relationships of the subject system and method will be obtained from the following detailed description and accompanying drawings which set forth illustrative embodiments and which are indicative of the various ways in which the principles of the subject system and method may be employed.

### BRIEF DESCRIPTION OF THE DRAWINGS

For a better understanding of the subject invention, reference may be had to preferred embodiments shown in the attached drawings in which:

FIG. 1 is a block diagram illustrating components of an exemplary network system in which the subject method may be employed; and

FIG. 2 illustrates an exemplary method for handling underperforming searches.

### DETAILED DESCRIPTION

The following generally describes a system and method for handling underperforming searches. More particularly, the following describes a system and method that will provide a means for a vendor to inform a customer that received an undesirable search result that the vendor now offers for sale product that the system and method subsequently determines is the product that the customer was most likely searching for. As will become apparent, the subject system and method provides a technical improvement to on-line search engines that otherwise suffer the problem that a customer may not be provided with relevant search results when performing a product search at a vendor website.

In online commerce, a customer can search for products and/or services to purchase (herein referred to as “product” or “products”) in several ways. Traditionally, and most commonly, a customer performs a keyword search. When performing a keyword search, a customer causes one or more keywords to be provided to a search engine that is associated with a website of a vendor. The search engine uses the keywords, which are extracted from the search query, to search for product within a database of product information and, responsive to a search query, the search engine returns to the customer a listing of product that the search engine determines is a “match” for the keywords provided by the customer, i.e., the product that the system determines the customer is looking for. Often, the providing of a search result entails the search engine ranking the products that are located by performance of the search and the product that is ultimately caused to be displayed to the customer by the search engine as a search result is the one or more products that have been given a rank by the search engine above a certain threshold. Search results can be, for example, images, categories, sub-categories, individual stock keeping units (SKUs), one or more catalog pages, etc.

To meet the goals and objectives set forth herein, product searches that rely upon customer provided keywords (or other data points extracted from a query, which can include image and/or sound information as well as textual information) are caused to be associated with one or more conversion values. A conversion value can be considered to be a measure of a value of a search. For example, a conversion value can reflect a percentage of the time that a customer provided search causes the search engine to provide the customer with a product (as opposed to generating a null search result), can reflect a percentage of time that a consumer navigates away from a website subsequent to the user receiving a search result. can reflect a percentage of time that the product provided by the search engine in response to the customer provided search is placed into a shopping cart associated with the website of the vendor, and/or a percentage of time that the product provided by the search engine in response to the customer provided search that was placed into the shopping cart associated with the website of the vendor is purchased by the customer. One or more of these conversion values are to be associated with one or more of the keywords that are provided by one or more customers and the conversion values that are associated with the keywords are preferably updated as searches continue to be provided to the search engine. The association between the conversion value(s) and the keyword(s) can be stored in a relational database that is associated with the vendor website. The conversion values and keyword associations can then be periodically monitored by the vendor system and, when a conversion value that is associated with one or more keywords associated with a previously executed, underperforming search, e.g., a search that did not result in product being located, result in a product being placed into a shopping cart, and/or result in a product purchase, exceeds a predetermined, threshold value, the customer and/or an employee of the vendor, can be informed that product that has been determined by the system to be relevant to their previous, underperforming search is now available from the vendor.

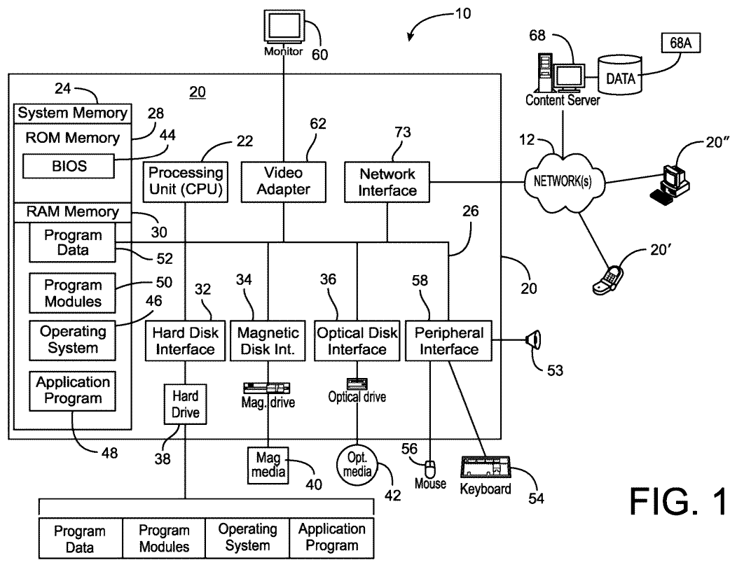

It is to be understood that the method described above is to be implemented within a computing environment having a plurality of processing devices linked via a network, such as a local area network and/or a wide area network. In this regard, a processing device 20, illustrated in the exemplary form of a computer system in FIG. 1, is provided with executable instructions to, for example, provide a means for a consumer, i.e., a user, to access a remote processing device, e.g., a vendor server system 68, via the network to, among other things, perform a search via use of a search engine supported by the remote processing device to obtain search results. Generally, the computer executable instructions reside in program modules which may include routines, programs, objects, components, data structures, etc. that perform particular tasks or implement particular abstract data types. Accordingly, those skilled in the art will appreciate that the processing device 20 may be embodied in any device having the ability to execute instructions such as, by way of example, a personal computer, mainframe computer, personal-digital assistant (“PDA”), cellular or smart telephone, tablet computer, or the like. Furthermore, while described and illustrated in the context of a single processing device 20, those skilled in the art will also appreciate that the various tasks described herein may be practiced in a distributed environment having multiple processing devices linked via a local or wide-area network whereby the executable instructions may be associated with and/or executed by one or more of multiple processing devices.

For performing the various tasks in accordance with the executable instructions, the processing device 20 preferably includes a processing unit 22 and a system memory 24 which may be linked via a bus 26. Without limitation, the bus 26 may be a memory bus, a peripheral bus, and/or a local bus using any of a variety of bus architectures. As needed for any particular purpose, the system memory 24 may include read only memory (ROM) 28 and/or random access memory (RAM) 30. Additional memory devices may also be made accessible to the processing device 20 by means of, for example, a SSD drive interface, a hard disk drive interface 32, a magnetic disk drive interface 34, and/or an optical disk drive interface 36. As will be understood, these devices, which would be linked to the system bus 26, respectively allow for reading from and writing to a hard disk 38, reading from or writing to a removable magnetic disk 40, and for reading from or writing to a removable optical disk 42, such as a CD/DVD ROM or other optical media. The drive interfaces and their associated non-transient, computer-readable media allow for the nonvolatile storage of computer readable instructions, data structures, program modules and other data for the processing device 20. Those skilled in the art will further appreciate that other types of non-transient, computer readable media that can store data may be used for this same purpose. Examples of such media devices include, but are not limited to, magnetic cassettes, flash memory cards, digital videodisks, Bernoulli cartridges, random access memories, nano-drives, memory sticks, and other read/write and/or read-only memories.

A number of program modules may be stored in one or more of the memory/media devices. For example, a basic input/output system (BIOS) 44, containing the basic routines that help to transfer information between elements within the processing device 20, such as during start-up, may be stored in ROM 28. Similarly, the RAM 30, hard drive 38, and/or peripheral memory devices may be used to store computer executable instructions comprising an operating system 46, one or more applications programs 48 (such as a Web browser), other program modules 50, and/or program data 52. Still further, computer-executable instructions may be downloaded to one or more of the computing devices as needed, for example, via a network connection. Data storage and/or processing can also be performed in the cloud as desired.

An end-user, e.g., a consumer, may interact with provided content, enter commands and information into the processing device 20 (e.g., a search query), etc. through input devices such as a touch screen or keyboard 54 and/or a pointing device 56. While not illustrated, other input devices may include a microphone, a joystick, a game pad, a scanner, a camera, etc. These and other input devices would typically be connected to the processing unit 22 by means of an interface 58 which, in turn, would be coupled to the bus 26. Input devices may be connected to the processor 22 using interfaces such as, for example, a parallel port, game port, firewire, or a universal serial bus (USB). To view information from the processing device 20, a monitor 60 or other type of display device may also be connected to the bus 26 via an interface, such as a video adapter 62. In addition to the monitor 60, the processing device 20 may also include other peripheral output devices, not shown, such as speakers and printers.

The processing device 20 may also utilize logical connections to one or more remote processing devices, such as the vendor server system 68 having one or more associated data repositories 68A, e.g., storing a database of product information, user related information (business contact information, demographic information, search history information such as searches performed/keywords used by the customer, and the like), keyword and conversion value associations, etc. In this regard, while the vendor server system 68 has been illustrated in the exemplary form of a computer, it will be appreciated that the vendor server system 68 may, like processing device 20, be any type of device having processing capabilities. Again, it will be appreciated that the vendor server system 68 need not be implemented as a single device but may be implemented in a manner such that the tasks performed by the vendor server system 68 are distributed to a plurality of processing devices linked through a communication network. Additionally, the vendor server system 68 may have logical connections to other third party server systems via the network 12 and, via such connections, will be associated with data repositories that are associated with such other third party server systems.

For performing tasks as needed, the vendor server system 68 may include many or all of the elements described above relative to the processing device 20. By way of further example, the vendor server system 68 includes executable instructions stored on a non-transient memory device for, among other things, handling search requests, providing search results, providing access to context related services, sending emails, determining conversions values, updating conversion value and keyword associations, determining when an update to a conversion value triggers a need to communicate with a customer, vendor representative, or the like, etc. Furthermore, it is to be understood that communications between the processing device 20 and the server system 68 may be exchanged via a further processing device, such as a network router, that is responsible for network routing. Communications with the network router may be performed via a network interface component 73. Thus, within such a networked environment, e.g., the Internet, World Wide Web, LAN, or other like type of wired or wireless network, it will be appreciated that program modules depicted relative to the processing device 20, or portions thereof, may be stored in the memory storage device(s) of the vendor server system 68.

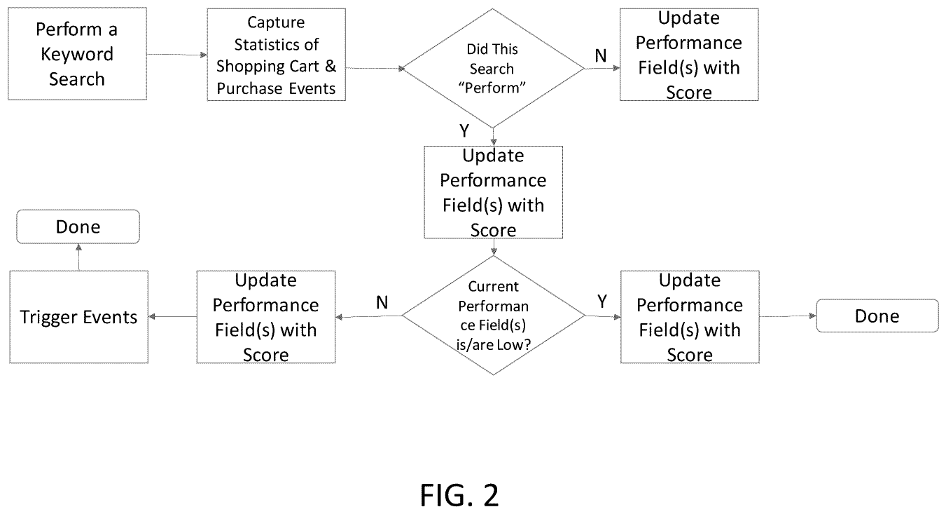

As noted above and as further illustrated in FIG. 2, as keyword searches are performed by various different users via use of the vendor server system 68, the vendor server system 68 will save the search histories, particularly the search terms utilized, in the database. Preferably, each search term is provided with its own record and the records of search terms can be further cross-referenced as desired. For example, the information stored in the database can note which search terms have been used in combination, the number of times the search terms have been used in combination, and the conversion value that is associated with the search terms individually and/or in one or more combinations. Thus, each record of search terms (one or more terms) is assigned one or more values each corresponding to one or more customer actions (e.g., a viewing, a purchase, a placing into a shopping cart, etc.) and each record of search terms is further preferably linked to one or more customers in order to allow the one or more customers to be notified in the event that a change in a record or records triggers a need for customer contact. To this end, when a record has a conversion value, e.g., a value indicating a purchase, below a certain threshold, a database field is set to indicate that fact and/or the records associated with underperforming search terms can be aggregated into a separate database.

As further noted above, the system continues to update these records as searches are performed and the system continues to monitor at least the records that are indicated within the data store to be associated with an underperforming search. In this manner, when the system determines that a conversion value associated with an underperforming search record achieves a predetermined value that indicates that the search is no longer to be considered to be underperforming, the system can remove the underperforming search designation from the record and perform a communicative action as required. More particularly, the underperforming records are monitored for conversion rates as the search term(s) are used over again by the same or different customers and, when it is determined that the underperforming search term(s) begin to “perform,” e.g., a conversion value indicates that sales of the product corresponding to the search result surpasses a threshold percentage, a series of triggers are generated. Search terms can start to perform, for example, when the vendor starts to carry a product or service that they previously did not. For example, a search for BOX WRENCH in January may underperform but, when the vendor expands their product line in March to now sell box wrenches, a search for BOX WRENCH in April will begin to perform and generate sales. Updating of a record can include using an average value over a predefined range of time or searches, using the last calculated average value, or the like as desired for any particular purpose.

When an update to one or more conversion values results in a determination that a search has transitioned from underperforming to performing, the following triggers actions could be performed: 1) each customer that had used, i.e., is linked to, the previously underperforming one or more search terms can be notified (e.g., through an email or through a message on the website when a customer signs in or a push notification to the vendor's mobile app the customer has installed on their mobile device) that the vendor now sells the product or service which the customer had previously searched for but was unable to find and purchase; 2) a vendor based account manager of each of those customers can be notified through, for example, an email or text message or a report that product that was previously searched for unsuccessfully by their customers is now available; 3) like-minded customers, e.g., customers have one of more characteristics in common with a customer providing an underperforming search, can be notified that a set of search terms is now performing, regardless of whether they had previously used those search terms; and/or 4) the account managers of those like-minded customers can be notified of this result for use as a possible sales opportunity. Notifying like-minded customers is particularly advantageous as it will be appreciated that like-minded customers are likely to have the same product needs, e.g., bakeries have similar buying habits of other bakeries (industries); safety engineers tend to have the same buying habits of other safety engineers (roles), etc. Account managers can be vendor employees that visit a customer on their premises or be vendor employees that perform sales activities predominantly over the phone.

As customer expectations of search engines increase over time, customers will start to ask for solutions to applications or situations (e.g., I have a flat tire, I spilled oil on a cement floor). With natural language processing, groups of applications and situations can be identified as being “the same”. For example, I have a flat tire, flat tire, my tire is flat, and my tire popped, all mean the same thing. Underperforming solution searches can be processed in the same way as underperforming search terms. A vendor may have zero SKUs to help address customer needs for a given situation at the time a search is first provided. However, as a vendor begins to carry items for a given situation, triggers can again be generated. Moreover, in October a vendor may have 3 SKUs which can help a customer address a given situation. If in November the vendor now carries 8 SKUs which can be used to address the given situation, again similar triggers can be generated. Furthermore, as search term processing improves, a solution search that should have generated a result and sale for a product that the vendor sells when initially provided by a customer may later provide the appropriate result with the prior searcher, account manager, and/or like-minded customer then being notified as above.

The subject system and method also has the advantage of not requiring the use of the search engine thus freeing up system resources. Specifically, the subject system and method does not re-run underperforming search terms. Rather, the subject system and method monitors the performance of a search (e.g., sales), especially keywords utilized in a search—which keywords may include model numbers or take into consideration parameters that accompany a search term (e.g., ½ ″ socket).

It will also be appreciated that other forms of search term input are possible. For example, searches that occur over a voice conversation (e.g., phone or in person at a store). Search terms can be discerned automatically from voice-to-text conversions. Images and video can also be used as search engine input. Email conversations between customers and their corresponding account manager can be processed to look for search terms using NLP (Natural Language Processing). All these cases will have sales performance values and the input can be treated as keywords per the above. For example, data points extracted from uploaded images can be stored in the database and linked to conversion values and customer information.

In some circumstances a user interface that is presented to a customer can also be modified to notify the customer when a previously used, unperforming search has been determined to be performing, i.e., the updated conversion value indicates that the search has a corresponding product category or specific product SKU. In the case of the customer using a drill-down search, the notification can be in the form of emphasis being placed in the user interface on a category or SKU user interface selection elements. In the case where the customer is using static or dynamically built catalog pages, emphasis on the page can be used to alert the customer that a category or SKU is now carried by the vendor.

While various concepts have been described in detail, it will be appreciated by those skilled in the art that various modifications and alternatives to those concepts could be developed in light of the overall teachings of the disclosure. In this regard, the solutions described herein can be used to notify a customer when additional accessories are carried for a given category or SKU. For example, a vendor may sell flashlights. As the vendor starts to carry more and more accessories for a given category or SKU, triggers can be generated. In the case of flashlights, accessories can be replacement bulbs, different types of batteries, belt clips, magnetic wall holders, etc. not all of which the vendor might carry at the time the vendor starts to sell flashlights.

Yet further, while various aspects have been described in the context of functional modules and illustrated using block diagram format, it is to be understood that, unless otherwise stated to the contrary, one or more of the described functions and/or features may be integrated in a single physical device and/or a software module, or one or more functions and/or features may be implemented in separate physical devices or software modules. It will also be appreciated that a detailed discussion of the actual implementation of each module is not necessary for an enabling understanding of the invention. Rather, the actual implementation of such modules would be well within the routine skill of an engineer, given the disclosure herein of the attributes, functionality, and inter-relationship of the various functional modules in the system. Therefore, a person skilled in the art, applying ordinary skill, will be able to practice the invention set forth in the claims without undue experimentation.

It will be additionally appreciated that the particular concepts disclosed are meant to be illustrative only and not limiting as to the scope of the invention which is to be given the full breadth of the appended claims and any equivalents thereof.

What is claimed is:

1. A method for handling underperforming searches, comprising:
receiving by a search engine coupled to a database of product information a search query having a datapoint;
using by the search engine at least the datapoint to generate a search result;
using by a vendor system associated with the search engine one or more interactions with the generated search result to update a conversion value that is linked within a datastore of the vendor system to the datapoint;
determining by the vendor system that the updated conversion value that is linked within the datastore to the datapoint was caused to exceed a predetermined, threshold value; and
when it is determined by the vendor system that the updated conversion value that is linked within the datastore to the datapoint was caused to exceed the predetermined threshold value, causing by the vendor system a notification to be sent to one or more consumers that previously provided to the search engine at least the datapoint.

2. The method as recited in claim 1, wherein the one or more interactions includes a consumer navigating away from a website associated with the vendor system subsequent to the user receiving the search result.

3. The method as recited in claim 1, wherein the one or more interactions includes a consumer placing into a shopping cart associated with a website of the vendor system one or more products included in the search results.

4. The method as recited in claim 1, wherein the one or more interactions includes a consumer purchasing via use of the vendor system one or more products included in the search results.

5. The method as recited in claim 1, wherein the conversion value reflects a number of times that the one or more interactions includes a consumer navigating away from a website associated with the vendor system subsequent to the user receiving the search result.

6. The method as recited in claim 1, wherein the conversion value reflects a number of times that the one or more interactions includes a consumer placing into a shopping cart associated with a website of the vendor system one or more products included in the search results.

7. The method as recited in claim 1, wherein the conversion value reflects a number of times that the one or more interactions includes a consumer purchasing via use of the vendor system one or more products included in the search results.

8. The method as recited in claim 1, wherein the datapoint comprises data extracted from a text-based search query.

9. The method as recited in claim 1, wherein the datapoint comprises data extracted from an image-based search query.

10. The method as recited in claim 1, wherein the datapoint comprises data extracted from an audio-based search query.

11. A non-transitory, computer readable media having instruction stored thereon, the instructions, when executed by a processing device, causing a vendor system to perform steps for handling underperforming searches, comprising:
causing a search engine coupled to a database of product information to generate a search result via use of a search query having a datapoint;
using one or more interactions with the generated search result to update a conversion value that is linked within a datastore of the vendor system to the datapoint;
determining that the updated conversion value that is linked within the datastore to the datapoint was caused to exceed a predetermined, threshold value; and
when it is determined that the updated conversion value that is linked within the datastore to the datapoint was caused to exceed the predetermined threshold value, causing a notification to be sent to one or more consumers that previously provided to the vendor system for use with the search engine at least the datapoint.

12. The non-transitory, computer readable media as recited in claim 11, wherein the one or more interactions includes a consumer navigating away from a website associated with the vendor system subsequent to the user receiving the search result.

13. The non-transitory, computer readable media as recited in claim 11, wherein the one or more interactions includes a consumer placing into a shopping cart associated with a website of the vendor system one or more products included in the search results.

14. The non-transitory, computer readable media as recited in claim 11, wherein the one or more interactions includes a consumer purchasing via use of the vendor system one or more products included in the search results.

15. The non-transitory, computer readable media as recited in claim 11, wherein the conversion value reflects a number of times that the one or more interactions includes a consumer navigating away from a website associated with the vendor system subsequent to the user receiving the search result.

16. The non-transitory, computer readable media as recited in claim 11, wherein the conversion value reflects a number of times that the one or more interactions includes a consumer placing into a shopping cart associated with a website of the vendor system one or more products included in the search results.

17. The non-transitory, computer readable media as recited in claim 11, wherein the conversion value reflects a number of times that the one or more interactions includes a consumer purchasing via use of the vendor system one or more products included in the search results.

18. The non-transitory, computer readable media as recited in claim 11, wherein the datapoint comprises data extracted from a text-based search query.

19. The non-transitory, computer readable media as recited in claim 11, wherein the datapoint comprises data extracted from an image-based search query.

20. The non-transitory, computer readable media as recited in claim 11, wherein the datapoint comprises data extracted from an audio-based search query.
